(19) United States
(12) Patent Application Publication
(10) Pub. No.: US 2013/0346426 A1
(43) Pub. Date: Dec. 26, 2013

(54) TRACKING AN ANCESTRY OF METADATA

(71) Applicant: JOHN O'BYRNE, Santa Clara, CA (US)

(72) Inventor: JOHN O'BYRNE, Santa Clara, CA (US)

(21) Appl. No.: 13/532,791

(22) Filed: Jun. 26, 2012

(51) Int. Cl. G06F 17/30

(52) U.S. Cl. 707/754; 707/769; 707/755; 707/E17.059; 707/E17.061

(57) ABSTRACT

An ancestry of a database metadata residing in a computer database is tracked by determining a lineage of all modifications performed on the database metadata. In one aspect, this is achieved by determining one or more attributes associated with the database metadata residing in a system database. Based upon the attributes, a database system table including corresponding tuple of the attributes is generated. Upon detecting a modification in the database metadata, a previous condition and a current condition of the attributes is recorded in the generated database system table. Upon receiving a request to track the ancestry of the database metadata, the database system table is queried to retrieve a lineage of the database metadata by retrieving one or more previous conditions and the current conditions of the attributes associated with the modification.

### TECHNICAL FIELD

The field generally relates to computer systems and software, and more particularly to software methods and systems to track an ancestry of database metadata.

### SUMMARY

Various embodiments of systems and methods to track an ancestry of database metadata are described herein. In an embodiment, to track the ancestry of a database metadata residing in a computer database, a lineage of all modifications performed on the database metadata are determined. A lineage of the modification includes a history of the database metadata, including one or more modifications endured by the database metadata or associated attributes. Determining a lineage includes determining the history from an origin of the database metadata to a current instance. Determining the lineage may provide a complete understanding about an initial condition of the database metadata, a current condition of the database metadata, a number of modifications, a type of modifications, a modification initiator, an owner of the database metadata, a date of creation of the database metadata, and the like.

In an embodiment, this is achieved by determining one or more attributes associated with the database metadata residing in a system database. Based upon the attributes, a database system table including a database description of the attributes is generated. Upon detecting a modification in the database metadata, a previous condition of the attributes is recorded and one or more attributes associated with the modification of the database metadata are updated with a current condition. Upon receiving a request to track the ancestry of the database metadata, the database system table is queried to retrieve a lineage of the modification of the database metadata by determining one or more previous conditions of the attributes associated with the modification.

These and other benefits and features of embodiments will be apparent upon consideration of the following detailed description of the embodiments thereof, presented in connection with the following drawings.

### BRIEF DESCRIPTION OF THE DRAWINGS

The claims set forth the embodiments with particularity. The embodiments are illustrated by way of example and not by way of limitation in the figures of the accompanying drawings in which like references indicate similar elements. The embodiments, together with its advantages, may be best understood from the following detailed description taken in conjunction with the accompanying drawings.

FIGS. 1A and 1B illustrate an overview of a method to track an ancestry of a database metadata, according to an embodiment.

FIG. 2 is a process flow diagram illustrating a computer-implemented method to track an ancestry of a database metadata, according to an embodiment.

FIG. 3 is a block diagram illustrating a computer system to track an ancestry of a database metadata, according to an embodiment

FIG. 4 is a block diagram illustrating an exemplary computer system, according to an embodiment.

### DETAILED DESCRIPTION

Embodiments of techniques for systems and to track an ancestry of a database metadata are disclosed herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

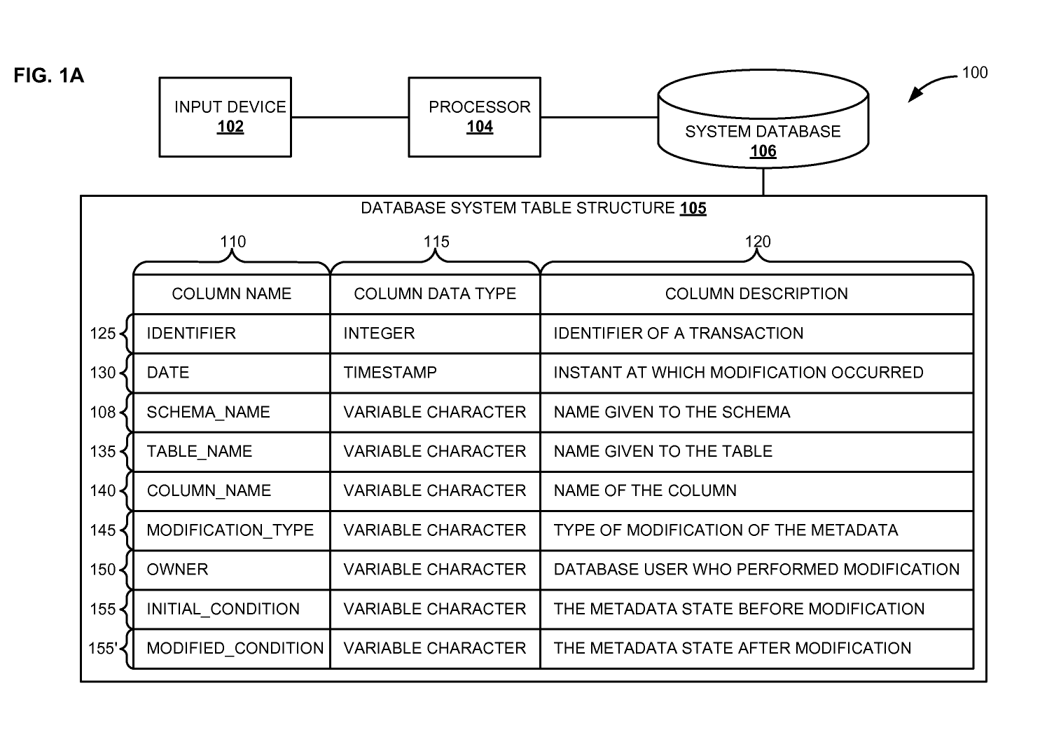

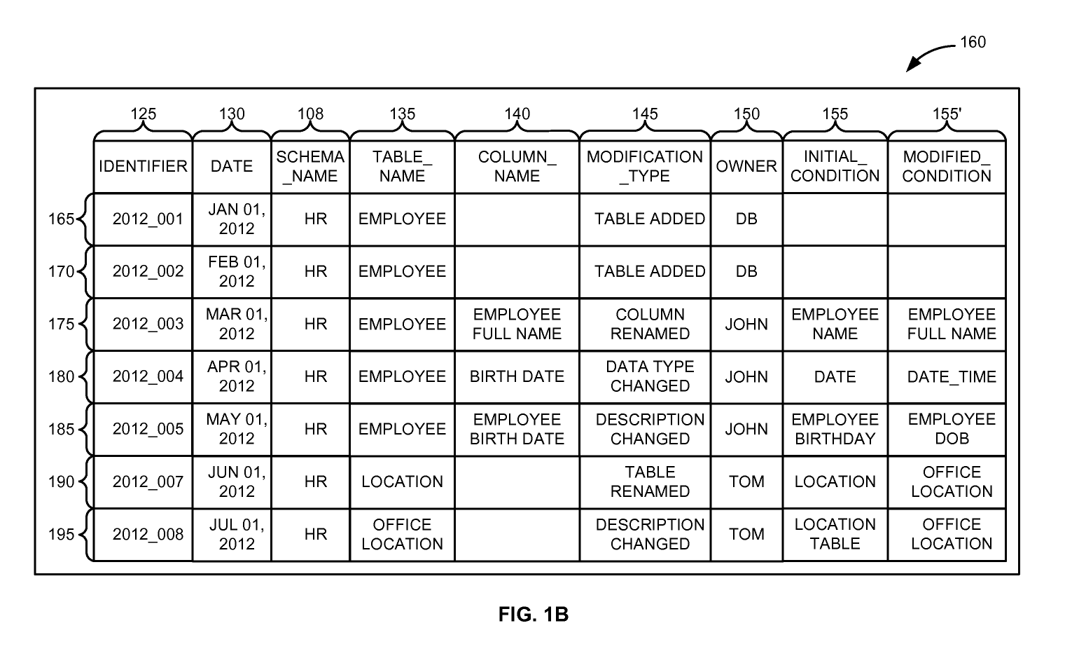

FIG. 1A illustrates an overview of a method to track an ancestry of a database metadata, according to an embodiment. Metadata represents data providing information about various aspects of associated data, which is managed and stored in a relational database; for instance, metadata of the data involved in an execution of a business processes. Database metadata includes a manner of generation of the associated data, an instance of generation of the data, a purpose of the associated data, a location of the generation, a location of storage, a location of an execution involving the data, and the like. Database metadata may also include schema names, database table names, database columns of an associated database table, and their tuple including data type, length, precision, scale and the like. The database metadata may be identified based upon a context and a reference associated with the database metadata. The context of the database metadata may further represent a circumstance and an environment of the database metadata, and the reference may represent an identification of the associated data. Database metadata are associated with attributes representing factors that define the data corresponding to the metadata. Attributes include values associated with the corresponding data. For instance, for a business data involved in determining sales forecast, the metadata includes the list of customers, revenue generated till date, geographical locations, production quantity, sales quantity, and the like. In an embodiment, the attributes and the tuples are represented as one or more entries (columns and/or rows) in the database system table. The data associated with the metadata includes actual information about entities corresponding to the database table, for e.g., CUSTOMER_{—}1, CUSTOMER_{—}2, and CUSTOMER_{—}3; revenue generated between JANUARY 2008 AND DECEMBER 2012; at locations USA, GERMANY, FRANCE, ITALY, INDIA, JAPAN, AND CHINA; and the like, that is generally rendered on a user interface (UI).

An ancestry of a database metadata represents a history or a record of the database metadata including information about one or more modifications ever since the origin of the database metadata. Tracking the ancestry of the database metadata involves determining a chronicle record of historic events involving the database metadata. Tracking the ancestry of a database metadata is helpful to comprehend the execution of a corresponding business process. Tracking the ancestry may include tracking a first condition and all the successive conditions of the metadata database, until a current condition. The conditions of the metadata database may be determined by a value represented by the database metadata, for example an initial value, one or more subsequent values and a final (or current) value of an element.

To efficiently track the ancestry of the database metadata, thereby track the associated conditions, a database system table that records various conditions of the metadata ever since an initial condition (or a previous condition) of the metadata is generated. The initial condition of the metadata may represent a first condition, when the metadata is generated or stored in the database for the first time. Computer system 100 includes an input device 102, processor 104, system database 106 and database system table structure 105 generated to record various conditions of the database metadata present in system database 106. Input device 102 is operable to modify the data associated with the metadata present in system database 106. Processor 104 of the computer system 100 recognizes the modification of the data and determines the corresponding modifications of the metadata by determining one or more attributes associated with the database metadata residing in system database 106. Processor 104 generates a database system table structure 105, including the attributes and corresponding tuples extracted from the database metadata. The attributes associated with the metadata are orchestrated in database system table structure 105 as one or more columns (COLUMN 110, 115, 120) and the tuple of the corresponding attributes are orchestrated in database system table structure 105 as one or more rows (ROWS 125, 130, 108, 135, 140, 145, 150, 155, 155′). A compilation of the rows and the columns renders a database system table structure 105. Database system table structure 105 represents an outline of the database system table (element 160 in FIG. 1B), and illustrates the attributes and the tuples that are associated in rendering the database system table. For instance, database system table structure 105, includes column name in column 110, where the column names of all the columns that are rendered in the database system table are listed. For example, identifier, date, schema name, table name, column name, modification type, owner, initial condition and modified condition are the column names of the columns that will be rendered in the database system table. Column 115 includes the data types of the corresponding columns, and column 120 includes a description about the data in the corresponding columns.

The processor 104 is configured to record the modifications by recording a previous condition of the attributes when a modification to the corresponding metadata is detected. Examples for the types of modifications of the metadata may include renaming one or more columns of the table, changing data type, adding one or more columns, removing one or more columns, renaming the table, removing a table, adding a table, modifying contents of the table, and the like. Recording the modifications include retaining one or more previous conditions of the database metadata residing in the table, and adding a new entry for every modification.

Recording the previous condition includes recording one or more values associated with the previous condition of the metadata corresponding to the attribute. For instance, if a value of an attribute “TABLE NAME” is modified from “JOHN_TEST TABLE_{—}1” to “JOHN_TEST_TABLE_{—}2”, the processor 104 detects the modification, and records the previous condition which was “JOHN_TEST_TABLE_{—}1” in the database system table along with corresponding tuple. Further, the processor 104 records the modified attribute with a current condition based upon the modification by changing “JOHN_TEST_TABLE_{—}1” to “JOHN_TEST_TABLE_{—}2”.

Upon receiving a request to track the ancestry of the database metadata, the processor 104 queries the database system table (element 160 in FIG. 1B) and retrieves a history of records associated with a query. Receiving a request to track the ancestry may include receiving a query term (or a search term), based upon which system database 106 is queried. The history of records represents the lineage of the metadata, and is determined by determining one or more previous conditions of the attributes associated with the modification. For instance, if a query term to track the ancestry of the database metadata is “TABLE NAME”, the processor 104 retrieves one or more previous conditions of the table name associated with the modification, to render a lineage of the “TABLE NAME”, by rendering a previous condition “JOHN_TEST_TABLE_{—}1” and a current condition “JOHN_TEST_TABLE_{—}2”.

In an embodiment, based upon a request to modify the database metadata, the database system table is queried to retrieve the lineage of the modification of the database metadata and the processor 104 determines attributes in the lineage of the modification that are configured to undergo a modification. Thus, the processor 104 determines the one or more attributes that may be affected by modification at a future instance.

In an embodiment, a database schema stores the database metadata as an orchestration of the attributes and the tuple, and accepts any modification of the attributes or the tuples based upon new information. The processor 104 is configured to detect any modifications of the database schema and queries the database system table to retrieve a lineage of the modification of the database metadata residing in the database schema.

In an embodiment, the processor 104 is operable to detect and correct one or more errors occurring while retrieving the lineage of the modification of the database metadata. For instance, while retrieving the lineage of a query “Customer Name”, the processor 104 may not be able to determine a column corresponding to “CUSTOMER NAME”, and thus returns an error message. This may occur when a table entry (column) of the corresponding column name is modified to “CUSTOMER FULL NAME” from “CUSTOMER NAME” during the process of modification of the metadata. However, since the database system table records the modifications by adding new entries in the table instead of replacing the existing ones, processor 104 detects the entry “CUSTOMER NAME” in the table 105, and corrects a mapping to recognize the table entry of the query from “CUSTOMER NAME” to “CUSTOMER FULL NAME”. The history of records represents the lineage of the “Customer Name” is thus determined by determining one or more previous conditions of “CUSTOMER NAME” associated with the modification.

Thus, the database system table includes all the modifications that have occurred in the database metadata. Business intelligence tools are designed to perform tasks of retrieving, analyzing and reporting data. The database system table may be used by the business intelligence tools to track the modifications that occur in the database metadata, and perform necessary tasks based upon the modification. Since the modifications are tracked, the modified metadata is efficiently available for synchronizing the system database, based upon a corresponding business process execution.

FIG. 1B illustrates a database system table 160 to track an ancestry of a database metadata, according to an embodiment. The processor 104 determines one or more attributes associated with the database metadata residing in system database 106 and generates database system table 160, including the attributes and corresponding tuples extracted from the database metadata. Database system table structure 105 represents an outline of database system table 160, including details about the required columns, corresponding data types and column description. Column 125 of database system table 160 represents the outlined element 125 present in column 110 of database system table structure 105. Similarly, all the columns (column 130, column 108, column 135, column 140, column 145, column 150, column 155, and column 155′) of database system table 160 correspond to the elements (element 130, element 108, element 135, element 140, element 145, element 150, element 155, and element 155′) of column 110 in database system table structure 105. Rows 165, 170, 175, 180, 185, 190, and 195 of database system table 160 represent the corresponding metadata entries. One or more entries (for e.g. rows) may be augmented to the database system table 160 based upon multiple modification of the database metadata and corresponding multiple modifications of the attributes. For instance, row 155′ is augmented to include an addition of an attribute represented in column 120, and row 155.

While querying the database system table 160, processor 104 parses the table to determine one or more historic modifications (column 155 of database system table 160) of the attributes based upon the modification of the database metadata. In an embodiment, database system table 160 may be filtered to exclude one or more rows or columns that are not associated with the modification. For instance, to determine an entire list of additions of new columns since Jun. 3, 2012, a query including a search term “additions of new columns since Jun. 3, 2012” is executed. While performing such a query, the processor 104 filters the columns that were added since Jun. 3, 2012; and excludes the other columns (for e.g. column 120, created on Jun. 1, 2012). The historic modifications of the attributes corresponding to the query elements are determined from the rows or columns that are associated with the modification.

Tracking the ancestry of the database metadata includes determining an initial condition and a current condition of the metadata based upon the attributes. Further, if the database metadata has undergone one or more modifications between the previous condition and the current condition, the corresponding modifications are determined. The determined ancestry is retrieved and rendered on a user interface as an ancestry of a lineage of metadata attributes. Determining the lineage of the database metadata present in system database 106 includes recording the modification of the database metadata, by recording a previous condition of the database metadata (column 155) and a current condition of the database metadata (column 155′). An intermediate condition of the database metadata may also be recorded to depict multiple modifications detected for the database metadata.

Lineage of database metadata recorded in database system table 160 includes a previous (initial) condition (column 155) of the database metadata prior to the modification. For instance, upon detecting a modification of the database metadata—COLUMN RENAMED in column 145, row 175 of database system table 160, the modification is recorded in database system table 160 by recording a previous condition and a current condition. This recording of the previous condition is represented by column 155, row 175 of database system table 160 which was previously EMPLOYEE NAME; and the current condition is represented by column 160, row 175 which is now EMPLOYEE FULL NAME. Column 125 for row 175 represents an identifier 2012_{—}003; column 130 of row 125 represents a date of creation MAR 01, 2012; column 108 of row 175 represents a schema name HR; column 135 for row 175 represents a table name EMPLOYEE; column 140 of row 175 represents a column name EMPLOYEE FULL NAME; column 145 of row 175 represents a type of modification COLUMN RENAMED; and column 150 of row 175 represents the owner who caused the modification of the metadata, JOHN. Column 155′ represents a current condition or a modified condition after the modification.

Thus, the previous conditions or the previous state of the attributes is not deleted; instead, a new entry is added to database system table 160 to represent each modification (e.g. initial condition in column 155, modified condition in column 155′, and the like). Thus, all the modifications are preserved in the database system table, until a current condition. Upon a request to retrieve the ancestry of the modifications, the lineage of database metadata is retrieved which includes all the modifications of the database metadata (e.g. initial condition in column 155, modified condition in column 155′, and the like). A compilation of the retrieved one or more conditions as a chronicle record of modifications of the database metadata generates the lineage of database metadata. The lineage of database metadata characterizes one or more previous conditions and the current condition of the modified database metadata.

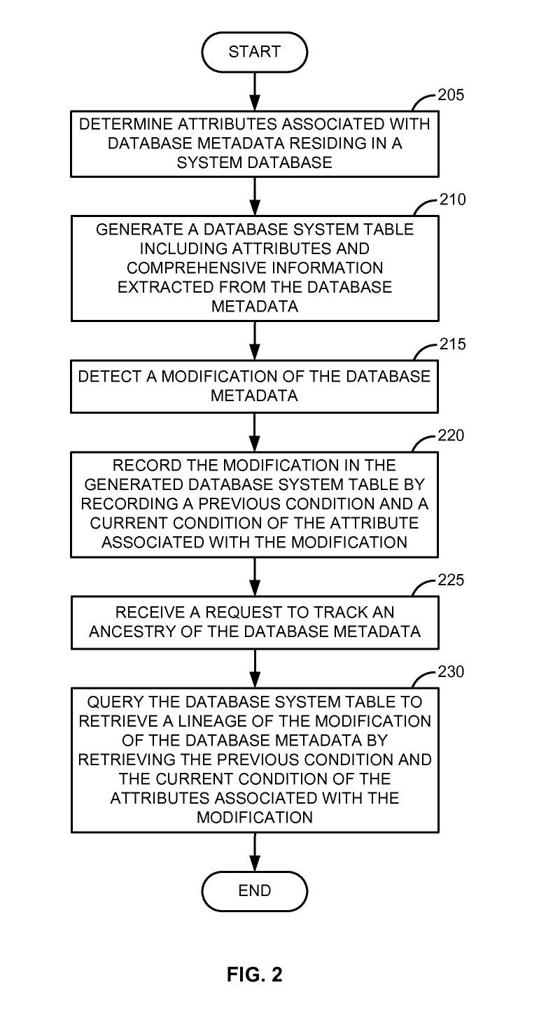

FIG. 2 is a process flow diagram illustrating a computer-implemented method to track an ancestry of a database metadata, according to an embodiment. At process block 205, attributes associated with the database metadata residing in a system database are determined. At process block 210, a database system table, including the attributes and corresponding tuple from the database metadata is generated. At process block 215, a modification of the database metadata is detected. In an embodiment, a modification of the database metadata is a consequence of a modification of a business data corresponding to the database metadata. At process block 220, the modification is recorded in the generated database system table by recording a previous condition and a current condition of the attribute associated with the modification. In an embodiment, the modification to the metadata may not be a first modification, and hence, the attribute associated with the modification corresponding to all the previous modification may be recorded in the database system table. At process block 225, request to track the ancestry of the database metadata is received. At process block 230 the database system table is queried to retrieve a lineage of the modification of the database metadata by determining the previous conditions and the current condition of the attributes associated with the modification recorded in the database system table.

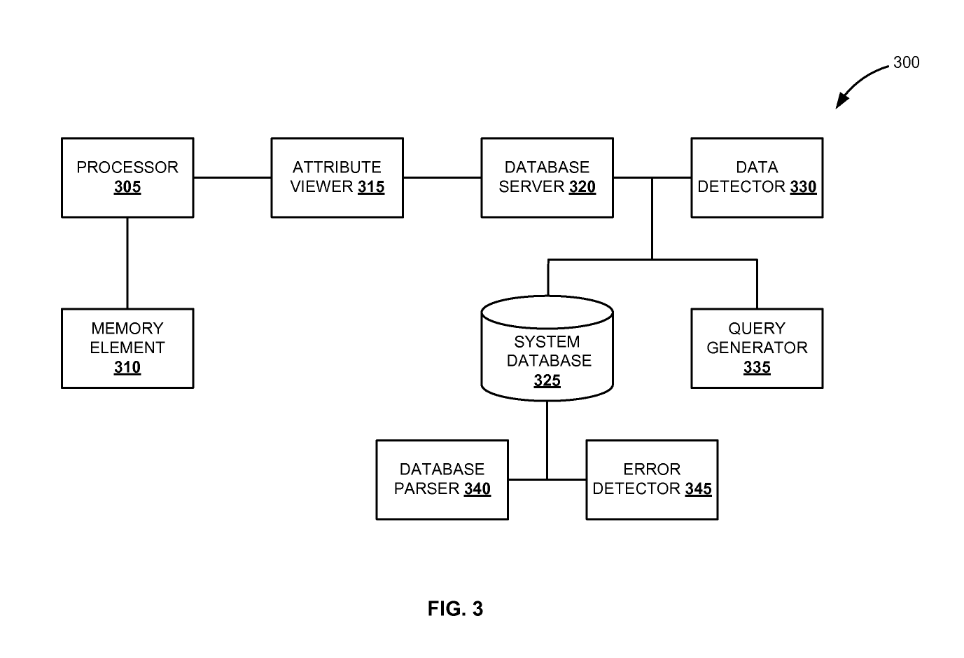

FIG. 3 is a block diagram illustrating a computer system to track an ancestry of a database metadata, according to an embodiment. Computer system 300 includes processor 305, memory element 310, attribute viewer 315, database server 320, system database 325, data detector 330, query generator 335, error detector 345 and database parser 340. In an embodiment, processor 305 is in communication with memory element 310 and attribute viewer 315. System database 325 is in communication with database server 320, data detector 330, query generator 335, error detector 345 and database parser 340. In an embodiment, processor 305 is configured to read and execute instructions stored in memory element 310.

In an embodiment, attribute viewer 315 determines one or more attributes that are associated with the database metadata residing in system database 325. Database server 320 generates a database system table based upon the determined attributes. The database system table generated may include tuple or a description of each attribute. Data detector 330 detects a modification in the database metadata, and records the modification by recording one or more previous conditions and a current condition of the attribute associated with the modification. Recording the modification of the database metadata includes adding a new entry in the generated database system table to indicate the modification; instead of removing or replacing the existing entries in the database system table.

Query generator 335 queries the database system table upon receiving a request to track the ancestry of the database metadata. Query generator 335 retrieves a lineage of the modification of the database metadata by retrieving the previous conditions and the current condition of the attributes associated with the modification. The lineage of the modification represents the ancestry of the database metadata according to an embodiment, where the lineage represents the ancestry of the database metadata, from an initial condition to a current condition. The initial condition may be described as a first state of the attribute prior to the modification. The current condition may be described as an instance when the metadata database is requested to track the modifications. In an embodiment, a storage device is used to record and store one or more previous conditions of the attributes.

In an embodiment, database server 320 augments the database system table to include one or more database rows and one or more database columns based upon multiple modifications of the database metadata and corresponding multiple modifications of the attributes. For instance, consider a modification of the database metadata to include a new column, indicating an inclusion of a new attribute CLIENT_ID; here, since the modification is an addition of a new attribute, the database system table will have to be modified accordingly by adding a new row indicating the new attribute CLIENT_ID and a new column indicating the change of metadata. In an embodiment, database parser 340 is included to parse the database system table to determine one or more historic modifications of the attributes based upon the modification of the database metadata. In another embodiment, error detector 345 is included to detect and correct one or more errors occurring while retrieving the lineage of the modification of the database metadata.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

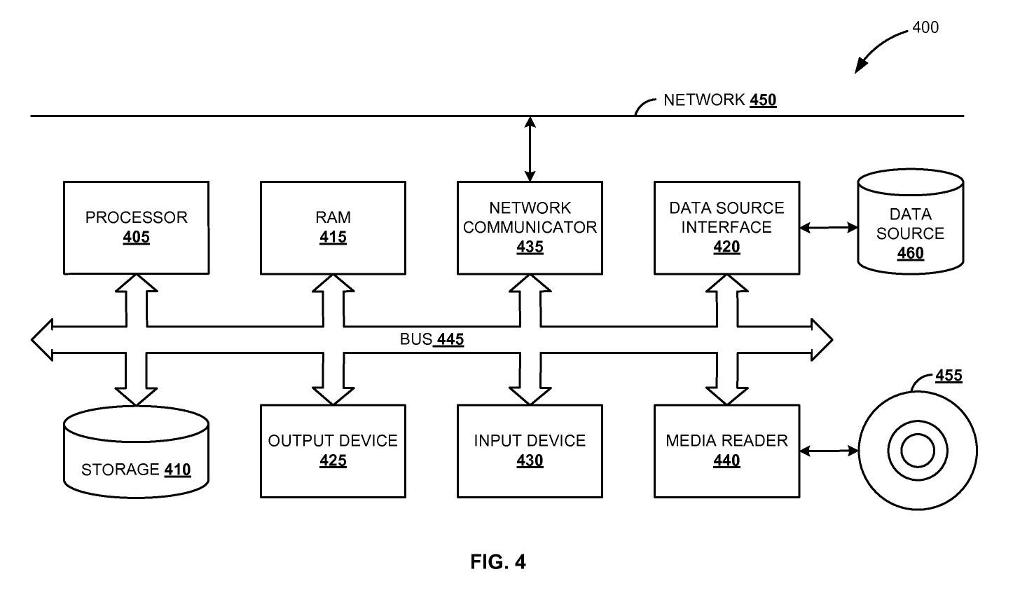

FIG. 4 is a block diagram illustrating an exemplary computer system 400, according to an embodiment. The computer system 400 includes a processor 405 that executes software instructions or code stored on a computer readable storage medium 455 to perform the above-illustrated methods. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment, the computer system 400 further includes an output device 425 (e.g., a display) to provide at least some of the results of the execution as output including, but not limited to, visual information to users and an input device 430 to provide a user or another device with means for entering data and/or otherwise interacting with the computer system 400. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, continuation servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In some embodiments the data source 460 may be accessed via an abstraction layer, such as, a semantic layer.

A data source is an information resource. Data sources include sources of data that enable data storage and retrieval. Data sources may include databases, such as, relational, transaction, hierarchical, multi-dimensional (e.g., OLAP), object oriented databases, and the like. Further data sources include tabular data (e.g., spreadsheets, delimited text files), data tagged with a markup language (e.g., XML data), transaction data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method, by a processor of the computer, to track an ancestry of a database metadata, comprising:
determining one or more attributes associated with the database metadata residing in a system database to generate a database system table including the attributes and corresponding one or more tuples extracted from the database metadata;
upon detecting a modification of the database metadata, recording the modification in the generated database system table by recording a previous condition and a current condition of the one or more attributes associated with the modification; and
upon receiving a request to track the ancestry of the database metadata, querying the database system table to retrieve a lineage of the database metadata by retrieving the previous condition and the current condition of the one or more attributes associated with the modification.

2. The computer implemented method of claim 1, wherein tracking the ancestry of the database metadata includes:
determining an initial condition of the database metadata based upon the associated attributes;
determining a current condition of the database metadata based upon the associated attributes; and
determining one or more modifications of the database metadata between the initial condition and the current condition, based upon the corresponding one or more modifications of the associated attributes.

3. The computer implemented method of claim 1, wherein generating the database system table includes:
determining the attributes associated with the database metadata;
determining the tuples of the attributes associated with the database metadata;
generating one or more database entries including the attributes and tuples of the corresponding attributes to compile the database system table.

4. The computer implemented method of claim 1 further comprising: preserving the previous condition of the attribute by preserving a previous value of the attribute prior to the modification, to record the modification.

5. The computer implemented method of claim 1 further comprising: updating the attribute with the current condition by updating the attribute with a current value based upon the modification.

6. The computer implemented method of claim 1 further includes: augmenting the database system table to include one or more database entries based upon multiple modifications of the database metadata and corresponding multiple modifications of the attributes.

7. The computer implemented method of claim 1, wherein querying the database system table includes: parsing the database system table to determine one or more historic modifications of the attributes based upon the modification of the database metadata.

8. The computer implemented method of claim 1, wherein querying the database includes: filtering the database system table to determine the historic modifications of the attributes corresponding to one or more query elements.

9. The computer implemented method of claim 1, wherein the lineage of the modification includes: a chronicle record of the modification of the database metadata, and a characterization of the previous conditions and the current condition of the modified attributes.

10. The computer implemented method of claim 1 further comprising:
detecting one or more modifications of a database schema storing the database metadata, and
querying the database system table to retrieve a lineage of the modification of the database metadata residing in the database schema.

11. The computer implemented method of claim 1 further comprising: detecting and correcting one or more errors occurring while retrieving the lineage of the modification of the database metadata.

12. The computer implemented method of claim 1 further comprising:
based upon a request to modify the database metadata, querying the database system table to retrieve the lineage of the modification of the database metadata; and
determining one or more attributes in the lineage of the modification, that are configured to undergo a modification.

13. A computer system to track an ancestry of a database metadata, comprising:
a processor configured to read and execute instructions stored in one or more memory elements; and
the one or more memory elements storing instructions related to—
an attribute viewer to determine one or more attributes associated with the database metadata, the database metadata residing in a system database;
a database server to generate a database system table including the attributes and corresponding one or more tuples of the attributes,
a data detector to detect a modification in the database metadata, to detect a modification and record the modification of the database metadata in the generated database system table; and
a query generator to query the database system table upon receiving a request to track the ancestry of the database metadata, and to retrieve a lineage of the modification of the database metadata by retrieving the previous condition and the current condition of the attributes associated with the modification.

14. The computer system of claim 13 further comprising a storage device to record one or more previous conditions of the attributes.

15. The computer system of claim 13, wherein the database server augments the database system table to include one or more database entries based upon one or more multiple modifications of the database metadata and corresponding one or more multiple modifications of the attributes.

16. The computer system of claim 13 further comprising a database parser to parse the database system table and to determine one or more historic modifications of the attributes based upon the modification of the database metadata.

17. The computer system of claim 13 further comprising an error detector to detect and correct one or more errors occurring while retrieving the lineage of the modification of the database metadata.

18. An article of manufacture including a non-transitory computer readable storage medium to tangibly store instructions, which when executed by a computer, cause the computer to:
determine one or more attributes associated with the database metadata residing in a system database to generate a database system table including the attributes and corresponding one or more tuple extracted from the database metadata;
upon detecting a modification of the database metadata, record the modification in the generated database system table by recording a previous condition and a current condition of the one or more attributes associated with the modification; and
upon receiving a request to track an ancestry of the database metadata, query the database system table to retrieve a lineage of the database metadata by retrieving the previous condition and the current condition of the one or more attributes associated with the modification.

19. The article of manufacture of claim 18 further includes: augmenting the database system table to include one or more database entries based upon multiple modifications of the database metadata and corresponding multiple modifications of the attributes.

20. The article of manufacture of claim 18 further comprising: detecting and correcting one or more errors occurring while retrieving the lineage of the modification of the database metadata.
